(19) United States
(12) Patent Application Publication
(10) Pub. No.: US 2013/0085889 A1
(43) Pub. Date: Apr. 4, 2013

(54) SYSTEMS AND METHODS FOR MANAGING RETURNS OR EXCHANGES MADE VIA A COMPUTER NETWORK

(71) Applicants: Samuel Stephen Fitting, Huntley, IL (US); Anil Kumar Gorre, Algonquin, IL (US); Scott David Houston, Naperville, IL (US); Michael Yakimisky, Algonquin, IL (US); Jerry Ray Buchanan, Aurora, IL (US)

(72) Inventors: Samuel Stephen Fitting, Huntley, IL (US); Anil Kumar Gorre, Algonquin, IL (US); Scott David Houston, Naperville, IL (US); Michael Yakimisky, Algonquin, IL (US); Jerry Ray Buchanan, Aurora, IL (US)

(73) Assignee: SEARS BRANDS, LLC, Hoffman Estates, IL (US)

(21) Appl. No.: 13/248,513

(22) Filed: Sep. 29, 2011

(51) Int. Cl. G06Q 30/06

(52) U.S. Cl. 705/26.35

(57) ABSTRACT

A method for allowing a user to manage at least one of a return or exchange of an ordered item. The method includes hosting an electronic database of information regarding item purchases, providing a user interface to allow a user to specify at least one return/exchange item, performing an authorization verification against the return/exchange of the item, providing to the user an identifier reflective of the authorization, and receiving and accepting the item(s) at the physical location within a predefined time limit.

### FIELD OF THE DISCLOSURE

The subject invention generally relates to systems and methods for returning and/or exchanging items via a computer network and, more particularly, relates to systems and methods for authorizing a return and/or an exchange of merchandise on a computer network, and for facilitating the return and/or exchange at a pickup location.

### BACKGROUND

In the art, systems and methods for ordering items via a computer network are generally known. For example, U.S. Pat. No. 7,124,098 discloses a system and method for online shopping that permits a customer to submit online orders for items from a store that serves both walk-in and online customers. The system and method provides an order cutoff time and an associated delivery window for items selected by a customer and accepts a customer's submission of a purchase order for an item if the time of submission is before the order cutoff time for that item. Similarly, U.S. Pat. Nos. 7,431,555; 6,928,415; and 6,871,184 each disclose a system and method for delivering items purchased over the Internet where items ordered by a particular time in the early evening are delivered by the next morning to a location that is within a 5-6 hour delivery radius of a stocking warehouse.

Still further, various online retailers allow a consumer access an retailer's online website, look up a product purchase, and generating a copy of the original receipt for returning/exchanging the item purchased on line in a store through normal return/exchange channels. In such instance, a consumer is able to provide the online retailer with information identifying the purchase, such as, the packing slip order ID or the original receipt number In addition, many other references disclose this concept and various iterations thereof.

While the background systems and methods identified herein, which are incorporated herein by reference in their entirety, generally work for their intended purpose, the subject invention provides improvements thereto, particularly by providing a consumer with the ability to create a specific return and/or exchange preauthorization code, notify a retail location of the impending return and/or exchange, notify the retail location of the consumer's estimated arrival, and/or speed the consumer through the return exchange process once in the retail location.

### SUMMARY

The following generally describes systems and methods for managing a return/exchange of items via a computer network, e.g., online, wired network, wireless network, dedicated system, cellular and/or mobile network, etc. Generally, the described systems and methods provide a user interface having user interface elements for allowing a user to specify the return/exchange item. The systems and methods perform an authorization verification against the return/exchange of the item, provide to the user an identifier reflective of the authorization, and allow for a physical store location to receive and accept the item within a predefined time limit.

While the forgoing provides a general explanation of the subject invention, a better understanding of the objects, advantages, features, properties and relationships of the invention will be obtained from the following detailed description and accompanying drawings which set forth illustrative embodiments and which are indicative of the various ways in which the principles of the invention may be employed.

### BRIEF DESCRIPTION OF THE DRAWINGS

For a better understanding of the present disclosure, reference may be had to various examples shown in the attached drawings.

FIG. 1 illustrates in block diagram form components of an example, online, retail, computer network environment.

FIG. 2 illustrates an example return and/or exchange system in accordance with the present disclosure.

FIGS. 3A-3B together illustrated a detailed flowchart of an example method and system for processing returns and/or exchanges in accordance with the present disclosure.

### DETAILED DESCRIPTION

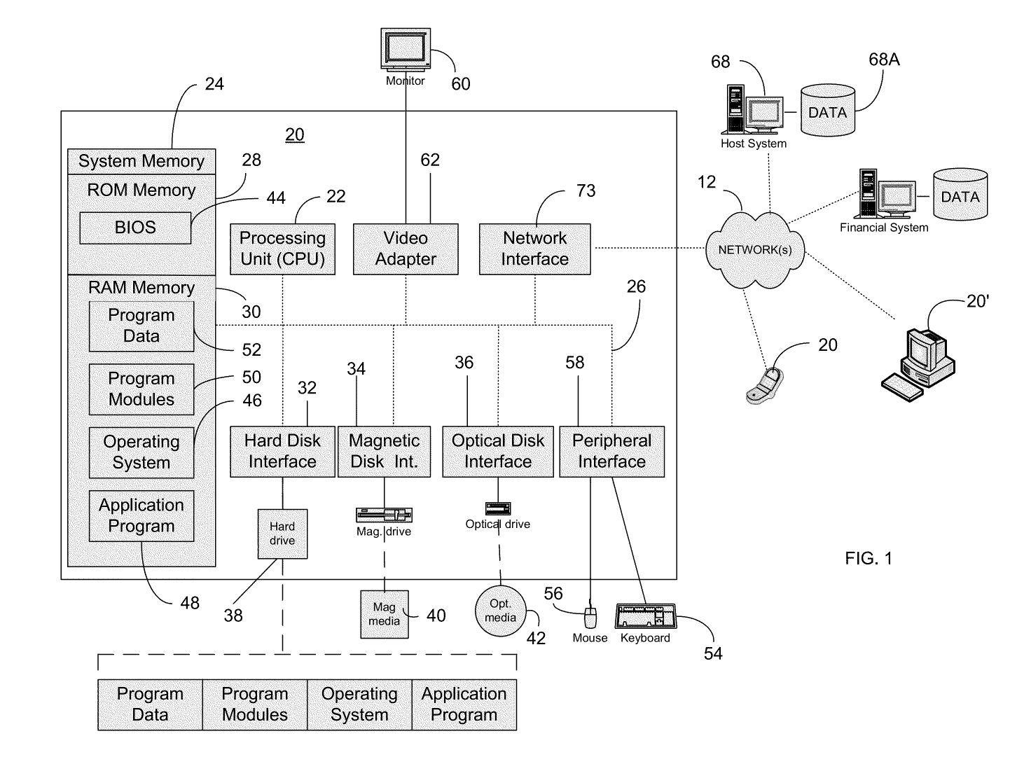

With reference to the figures, the following describes various systems and methods for managing returns and/or exchanges made via a computer network. To this end, a processing device 20, illustrated in the exemplary form of a computer system, is provided with executable instructions to, for example, provide a means for a consumer, e.g., a user, customer, etc., to access a vendor system server 68 and, among other things, schedule and/or manage the return and/or exchange of items at a retail location, schedule and/or manage return and/or exchange of the items, notify the retail location of the estimated arrival time of the consumer, and/or request that exchange items be placed on hold at a retail establishment. Generally, the computer executable instructions reside in program modules which may include routines, programs, objects, components, data structures, etc. that perform particular tasks or implement particular abstract data types. Accordingly, those of ordinary skill in the art will appreciate that the processing device 20 illustrated in FIG. 1 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those of ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those of ordinary skill in the art will further appreciate that other types of non-transitory computer readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

As noted, the processing device 20 may also utilize logical connections to one or more remote processing devices, such as the vendor system server 68 having associated data repository 68A. In this regard, while the vendor system server 68 has been illustrated in the exemplary form of a computer, it will be appreciated that the vendor system server 68 may, like processing device 20, be any type of device having processing capabilities. Again, it will be appreciated that the vendor system server 68 need not be implemented as a single device but may be implemented in a manner such that the tasks performed by the vendor system server 68 are distributed amongst a plurality of processing devices/databases located at different geographical locations and linked through a communication network. Additionally, the vendor system server 68 may have logical connections to other third party systems via the network 12 and, via such connections, will be associated with data repositories that are associated with such other third party systems. Such third party systems may include, without limitation, systems of banking, credit, or other financial institutions, systems of third party providers of goods and/or services, systems of shipping/delivery companies, etc.

For performing tasks as needed, the vendor system server 68 may include many or all of the elements described above relative to the processing device 20. In addition, the vendor system server 68 would generally include executable instructions for, among other things, making items available for exchange and/or return at a retail store location, providing a user wishing to exchange and/or return an item with remote access to a central record of purchase data in order to generate and provide the customer with a specific return and/or exchange receipt, accessing current inventory and item availability data, providing means to direct the customer to the nearest location that is able to process the exchange and/or return of the desired item, providing a means for the user to request that exchange ordered product be placed on hold at a retail establishment and facilitating any such hold request, notifying the identified retail store location of the impending return and/or exchange, notifying the retail location of the consumer's estimated arrival, and/or speeding the consumer through the return exchange process once in the retail location by, for example, processing the return/exchange at a prescheduled time and/or in a predetermined time limit.

Communications between the processing device 20 and the vendor system server 68 may be exchanged via a further processing device, such as a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the non-transitory memory storage device(s) of the vendor system server 68.

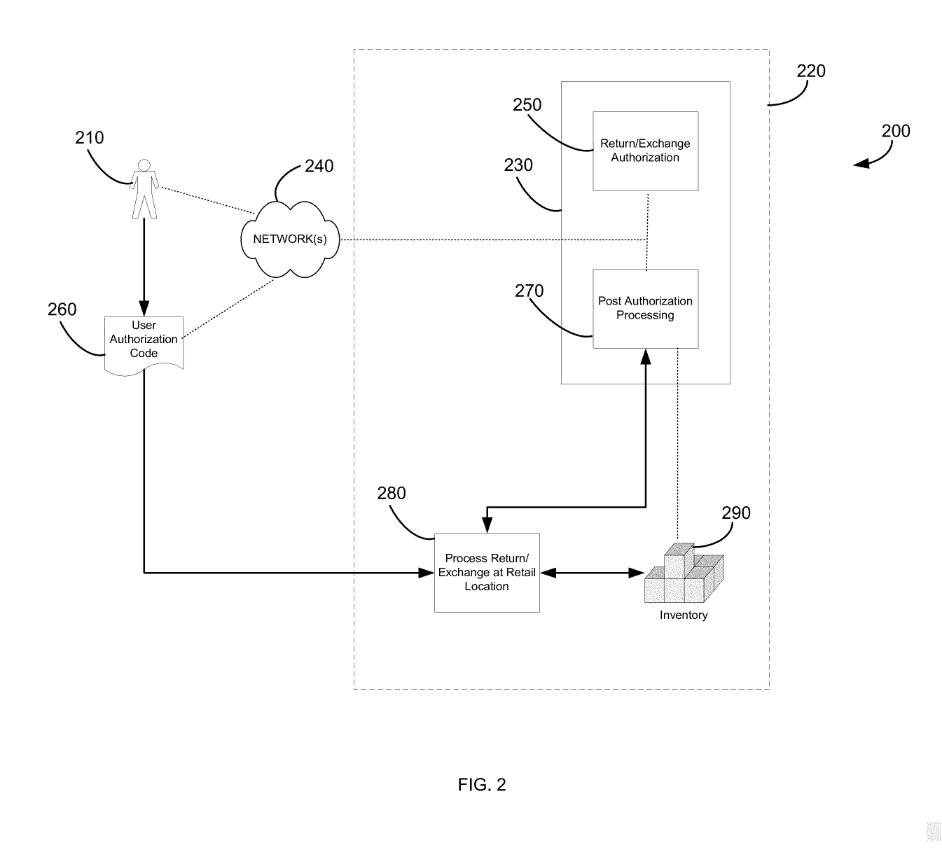

Referring to FIG. 2, there is illustrated a return/exchange system 200 in accordance with an example of the present disclosure. The system 200 is well-suited for operation on a remote network, such as, for example, the Internet, cloud, mobile network, cellular network, or other suitable wired and/or wireless network. The system 200 may be implemented n various other communication networks and/or mediums as desired.

Generally speaking, the system 200 is operable to facilitate the return and/or exchange of goods purchased from a retail establishment, either on-line or through a physical location, as quickly and efficiently as possible. For example, a consumer 210 (e.g., a user, customer, purchaser, gift recipient, etc.), having previously purchased and/or otherwise legally received at least one item from a merchant 220 initiates a process by which the consumer 210 wishes to return and/or exchange at an affiliated physical location, such as a retail store, warehouse, etc. In this example, the consumer 210 remotely accesses an authorization unit 230, through any suitable remote or local network 240, such as the Internet. The system 200 provide a user interface having user interface elements for allowing a user to specify the return/exchange item, and/or to provide relevant information to the system 200 to identify the user and/or the merchandise being returned/exchanged. While the consumer 210 is illustrated as being located separate from the location of the merchant 220 it will be appreciated that in other examples, the consumer 210 may be located within the merchant location, such as, for instance at a terminal located within a physical retail establishment.

Once the consumer initiates the return/exchange request, a return/exchange authorization module 250 processes a return authorization. In general, the authorization module 250 checks for return and/or exchange eligibility (e.g., verifies the return/exchange against predefined accounting and/or policy rules), confirms the items eligible to be processed by the consumer 210, generates an authorization record for use by the system 200 and generates an authorization code 260 for use by the consumer 210. The authorization record may be temporarily stored in an electronic database and/or otherwise made available to a post authorization module 270 for further processing. It will be understood, that the authorization module 250 may generate a user interface for the consumer 210, which provides the consumer 210 with interface elements to input or otherwise provide information to the authorization module 270. This display interface may include a web page, an application, a mobile application, a terminal, a scanner, or other similar input device. Still further, in one example the authorization module 250 may gather information from the consumer 210 including the desired retail store location 280, as well as an estimated and/or prescheduled arrival time (e.g., an appointment) by the consumer 210 at the store location 280. It will be further understood that in some examples, the authorization module 250 may process multiple items for return/exchange in any combination as desired.

Upon creation of the authorization record, the example post authorization processing module 270 stores the authorization information at the appropriate enterprise system, ensures that there are no duplicative and/or pending returns/exchanges for the desired transaction and provides the authorization code 260 to the consumer 210. The authorization code 260 may be provided via any suitable mechanism, including for example, via the network 240, mail, email, short message service (SMS), printout, etc. The authorization code 260 may be any suitable combination of identification codes including images, alphanumeric characters, codes, bar codes, passwords, or other suitable identifier.

The post authorization module 270 may also communicate with the desired store location 280 to inform the store of the impending return/exchange, and to provide the store location 280 with the estimated and/or prescheduled time of arrival as well as the authorization information. In one example, to ensure that the return/exchange may be performed in a expedited manner (e.g., within a desired time period), the module 270 may perform an inventory check against inventory 290 stored at the preferred store location 280 to ensure that the return and/or exchange can be properly handled at the location. The module 270 may inform the consumer 210 of any issues that may arise with the consumer's desired store location 280, (e.g., store closed, lack of or limited inventory, lack of ability to handle a return of this type and/or at the estimated/scheduled time, etc.), and may suggest alternative store locations that may be able to meet the consumer's desired level of service. Additionally, the post authorization module 270 may monitor the return process to verify that the return/exchange has taken place, and if not, to notify and/or remind the consumer 210 of the authorization to proceed. As desired, the post authorization module 270 may expire, “time out”, or otherwise close the authorization code for any valid reason such as, for example, a depletion of inventory, lack of response by the consumer 210, or any other suitable reason.

After receipt of the user authorization code 260, the consumer 210 may initiate an in store return at the chosen store location 280. In this example, the entire in-store return/exchange process may be completed in an expedited fashion, for example in no more than five minutes, because of the pre-authorization code. In at least one example, the store location 280 may provide a separate return/exchange location, terminal, and/or customer service individual to facilitate the expedited processing of the return/exchange, i.e., the consumer 210 may be able to “skip” the normal customer service window because the return is already pre-authorize and/or there is no cash register involvement necessary.

Still further, to speed up processing time even further, the system 200 may include the ability to provide or otherwise identify an estimated time of arrival of the consumer 210, and/or allow the consumer to schedule a time for the return/exchange. This estimated time may be provided in advance by the consumer 210 (e.g., by scheduling the time with the authorization unit 230), by calling and/or otherwise informing the store location 280 directly of an arrival time, by providing location information via a mobile device (e.g., a cell phone, mobile tablet, GPS device, vehicle identification system, etc), or by any other suitable notification technique.

In either instance, namely the consumer 210 arrives without prior notification, or the consumer 210 arrives after notifying the store location 80 of their impending arrival, the in-store return is processed via the store location 280. Specifically, in the example methods and system 200, the consumer 210 provides the authorization code 260 and the identified items to the store location 280. With receipt of the authorization code 260, the store location 280 accepts the merchandise from the consumer 210, confirms the condition and nature of the merchandise, confirm the return and provides the consumer with a return sales receipt. In the instance where the consumer 210 desires an exchange, the store location 280 accepts the return merchandise from the consumer 210, confirms the condition and nature of the return item, provides the consumer 210 with a suitable exchange item, and provides the consumer 210 with confirmation of the exchange and with an exchange receipt. In at least some instance, such as, for example when the consumer 210 provides an advance warning of their arrival, the store location 280 may pull or otherwise segregate and/or prepare the exchange merchandise for the consumer before-hand, thereby even further speeding the consumer 210 through the exchange process.

Once the return and/or exchange is completed, the store location 280 notifies the proper accounting system of the return/exchange, stores the transaction record, and completes the necessary record processing to ensure the return/exchange is properly accounted for by the system 200

In this manner, a consumer 210 may expedite the time and patience consuming process of returning and/or exchanging goods by pre-authorizing the return/exchange, and providing the pre-authorization code to the proper store location. Further, in this manner, the store location 280 may speed the consumer 210 through the exchange/return process, due at least to the pre-authorization and/or the lack of traditional point-of-sale (e.g., cash-register) involvement. Finally, in at least one example, the store location 280 may provide incentives to its employees and/or the consumer 210 by guaranteeing performance goals (e.g., return/exchange in five minutes) and incentivizing the meeting of those goals through discounts, refunds, etc. Still further, by pre-authorizing a return/exchange, confusion and/or delays at the store location 280 may be diminished by avoiding issues with receipt location, lack of inventory, delays due to lines and/or processing issues, etc. Thus, the entire return/exchange process may be turned into a positive experience for the consumer 210.

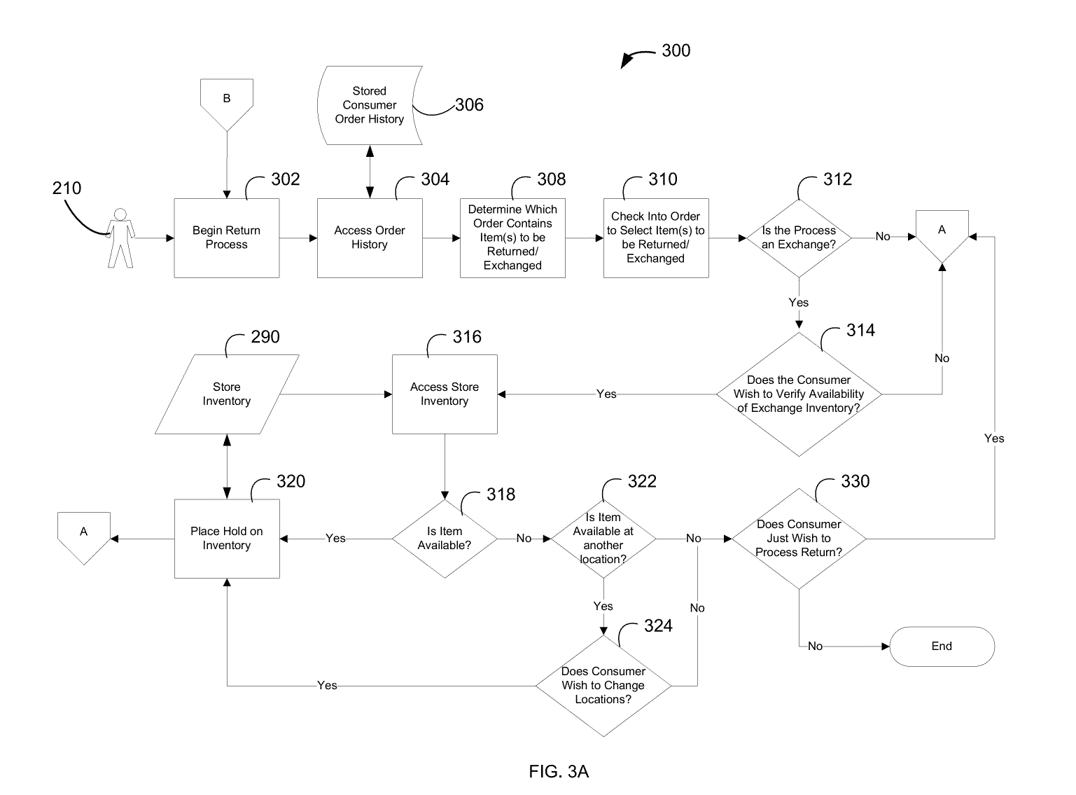

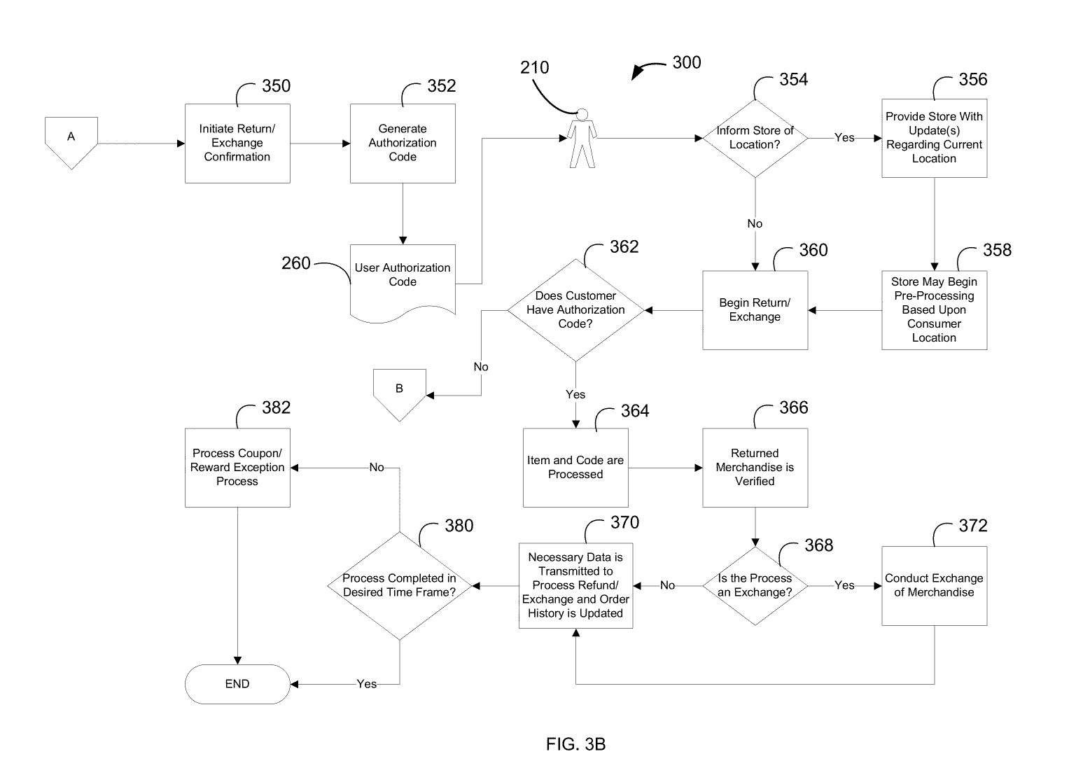

FIGS. 3A-3B together illustrated a more detailed flowchart 300 of an example method and system for processing returns and/or exchanges in accordance with the teachings of the present disclosure. In the illustrated example, a return process begins at block 302 where the consumer 210 begins the return process. In this process, the system 200 will provide the consumer 210 with at least one of a plurality of interface options to provide basic information to the system 200, and to identify the consumer 210 as well as the merchandise that the consumer 210 wishes to return and/or exchange. In this example, the consumer 210 is presented with a graphical user interface including user interface elements which allow the user the ability to login, search, scan, and/or otherwise locate the original purchase receipt and/or purchase data. The device upon which the graphical user interface may appear is any suitable device or display, such as, for example, a personal computer, a mobile device, a tablet, a terminal or similar device.

Once the information is provided, at block 304 the system 200 will access a stored consumer order history 306 provided in an enterprise database such as, for example, a centralized or distributed customer record database, accounting database, or any other suitable records storage facility. If, the system 200 cannot access the stored consumer order history 306, or if the particular order history for the merchandise and/or consumer cannot be identified, the consumer may be presented with options to provide further information, or the consumer may be asked to participate in a traditional non-authorized return/exchange process.

Once the system 200 identifies the consumers order, the system 200 will determine which consumer order(s) contain the item(s) to be returned/exchanged at block 308. Upon identifying the particular order(s) containing the item(s), the system 200 will allow the consumer 210 to identify which of the order item(s) the consumer 210 wishes to return/exchange at block 310. As will be appreciated, the selection process may comprise any known or yet to be developed selection process including, for example, selecting items form a graphical user interface, scanning the items, inputting data regarding the items, etc. Moreover, depending upon the item selected, the system 200 may require further information and/or assurances by the consumer 210.

In conjunction with the selection of the item(s) to be returned, a block 312 the consumer 210 is provided with the ability to identify whether the process is a straight return (e.g., return the item(s) for money, credit, and/or other consideration) or whether the consumer wishes to exchange the item(s) for other merchandise. If the consumer 210 simply wishes to return the item, the system continues processing at block 350 (see FIG. 3B). If, however, the consumer wishes to exchange an item, processing continues at block 314 where the consumer 210 is presented with the ability to instruct the system 200 to determine whether the desired item on exchange is available. If the consumer 210 does not wish to pre-determine availability of the exchange item, processing continues at block 350 as previously noted.

In order to determine availability of exchange inventory, at block 316, the system 200 accesses store inventory 290. The system 200 may present the consumer 210 at least one option regarding the available inventory, including, for instance, the same item, items of different color, items of different sizes, similar items suitable for replacement, etc. The consumer 210 may elect to exchange the merchandise for any of the presented options, or may alternatively decide to browse the store inventory when exchanging the item. If the system 200 determines that the item is available at block 318, the system 200 may place a hold on the inventory at block 320. The hold may be for any desirable period, including, for example, for a predetermined time limit. Additionally, system 200 may request the store location 280 to physically pull the item from inventory to keep the item accessible for exchange. In one example, the block 320 will request the store location 280 place a hold on at least one item selected for exchange, hold the item at a convenient location, and allow the consumer 210 to try on, view, inspect, or otherwise select the desired exchange item at the store location 280. In this way, the consumer 210 may be able to preselect at least one item, such as different sizes of an item, different colors, different designs, etc., and make a final decision at the store location 280 while still taking advantage of a pre-authorized exchange offered by the system 200.

Returning to block 318, if the system 200 determines that the desired exchange inventory is not available at the preferred and/or closest store location 280, the system 200 may determine whether the exchange inventory is available at another location in the retail supply chain at block 322. If the item is available at another location, the system 200 may make an algorithm decision to relocate the inventory if possible, thus making the inventory availability issue transparent to the consumer 210, or a block 324, the system 200 may ask the consumer 210 if the location of the exchange inventory location is convenient and/or acceptable for a visit by the consumer 210. If the consumer 210 wishes to accept the location of the exchange inventory, the system 200 will note the store location and process will continue at the block 320, thereby placing a hold on the inventory.

If the system 200 determines that the exchange merchandise is not available at another location, or if the available location is not acceptable to the consumer 210, at block 330 the system 200 will determine whether the consumer 210 wishes to process the item as a return only, foregoing the exchange of goods. At this point, the consumer 210 may choose to proceed as a return only, and process control is passed to block 350. Alternatively, the consumer 210 may choose to terminate the exchange process by declining to proceed as a return, at which point the consumer 210 may wish to retain the item in question, or may try the system 200 again at a later time. If at least one example, the consumer 210 may request that the system 200 monitor the inventory 290, request modifications to the inventory 290, and/or otherwise keep the consumer informed of when the exchange inventory is available.

Turning now to FIG. 3B, once the system 200 has identified all of the circumstances regarding the return/exchange, the system 200 initiates a return/exchange confirmation at block 350. In this example, the confirmation includes an identification of the consumer 210 information, an identification of the refund method (if any), an identification of the item(s) to be return and/or exchanged, and an identification of the store location that is authorized to process the return/exchange. While the system 200 may pre-authorize a specific store location 280, it will be appreciated that in some examples, any location in the retail enterprise may be utilized to process the return and/or exchange. In these examples, however, the gains in speed, convenience, and/or efficiency may not be as great as if the consumer 210 processes the return/exchange at the noted store location 290.

After compiling all of the necessary information, the system 200 generates the authorization code 260 at block 352. As described previously, the authorization code 260 may comprise any suitable combination of images and/or characters to identify the authorization record. In at least one example, the system 200 may also perform accounting pre-authorization steps, such as, pre-authorizing credit card returns and purchases, crediting and/or debiting monetary accounts, updating rewards and/or frequent shopper accounts, and/or any other similar activity. Furthermore, the user authorization code 260 may be provided to the consumer 210 is any variety of suitable manners including, for instance, via mail, email, fax, SMS, etc.

Once the consumer 210 has the user authorization code 260, or as will be described later, if the consumer 210 fails to obtain the authorization code 260 but still wishes to initiate a return/exchange, the consumer 210 may proceed to the store location 280. In this example, at block 354, the system 200 allows the consumer 210 the option of providing the consumer's current location to the store 280. If the consumer 210 decides to provide the system 200 with a determine their location, at block 356 the system 200 will be provided with at least one update as to the consumer's location status. In this example, the location status may be provided through any suitable status notification means, including, for instance, zip-code, GPS tracking, phone location, cell phone location, status updates (e.g. via social networking, etc.), mobile application, direct calling, SMS, and/or any other location identification means.

Based upon the location of the consumer 210, the system 200 may determine and/or may be provided with an estimated and/or scheduled time of arrival. Alternatively, the consumer 210 may fail to provide location information and/or schedule a time, but instead may still choose to provide the store 280 with an estimated time of arrival while providing the pre-authorization information (e.g., expected time that the consumer will be at the physical location). In any instance, based upon the time of arrival, at block 358 the store 280 may begin pre-processing of the exchange/return as desired. For example, the store 280 may pull the exchange item(s) from inventory and have the item(s) ready for pick-up and/or examination (e.g., try-on), and/or the store 280 may insure that it has a customer service associate ready for the consumer 210 arrival.

Once the consumer 210 arrives at the store 280 (in either instance of the store knowing or not knowing the location and/or time of arrival of the consumer 210), the consumer 210 may begin the return/exchange of the item at block 360. In order to begin the return/exchange, the system 200 may first determine whether the consumer 210 has a proper authorization code at block 362. In this step, the system 200 may scan, or otherwise allow input of the authorization code into the system 200. If the customer does not have a proper authorization code, or if the customer does not have any authorization code, the system 200 may return the process to block 302 to start the process of obtaining a proper authorization code. The authorization code may be provided to the system 200 through any suitable means, including scanning, inputting, etc.

After the authorization code is provided to the system 200, the code and the return item(s) are processed at block 364. In this example, a self-service terminal and/or a customer service terminal is provided with the details of the transaction including the item(s) to be return, and if applicable, the item(s) to be exchanged. The accounting information regarding the transaction may also be provided to allow the customer and/or the customer service representative to verify the accounting details of the transaction. At block 366 the item(s) to be returned are verified against the retrieved details of the transaction to ensure that the expected item(s) are being returned and/or that the items in an acceptable form for return. If the merchandise returned is not acceptable (for any reason), the entire return transaction may be either cancelled completely, or may be put in a hold status until the proper merchandise is presented, or until the quality of the goods is properly authorized (e.g., by a manager, etc).

At some point during the return/exchange process, the system 200 determines whether the process is a return or an exchange, such as at block 368. If the system 200 determines that the process is simply a return, system process moves to block 370, where the necessary data is transmitted to the proper enterprise systems to finalize the transaction. In this example, the transaction data may be provided to accounting, customer records, etc. to close the open transaction and to complete the return/exchange an any known fashion. If, however, the system 200 determines that the process is an exchange, the exchange is physically conducted at block 372. In this instance, the customer 210 may be able to inspect, try-on, select, and/or otherwise approve of the exchange merchandise at the store location. Once the exchange is performed, the system 200 process the return/exchange at block 370 to close the transaction.

In the example illustrated, at block 380, the system 200 may determine whether the exchange/return process, from the beginning of the return/exchange (block 360) to the completion of the return/exchange process (block 370) took less that desired time frame. In one example, the retail establishment may denote a target return/exchange time of a guaranteed time, such as a “return/exchange in five minutes”. In yet another example, the retail establishment may denote a guaranteed completion time base upon the scheduled versus the actual return/exchange time. The system 200 generally allows the meeting of these performance goals due at least to the pre-authorization of the return/exchange, the identification of the customer location relative to the store at which the return/exchange is to take place, the ability of the system to identify inventory prior to the return/exchange, and/or the ability of the customer to skip the regular cash-register return line because of the pre-authorization. In these instances, the retail establishment may provide incentives to the consumer if the performance goals are not met at block 382. These incentives may take the form of coupons, monetary rewards, loyalty/membership points and/or rewards, or any other desired incentive. After determination of the time to completion, the example system 200 terminates the return/exchange process.

It will be further appreciated that in at least some examples, the system 200 may perform verification of authorization based upon predefined accounting or policy rule to provide authorization for the return or exchange of the item. For example, when the user is presented with the user interface and provide information regarding the return/exchange item, the system 200 may conduct a verification to insure that the item is from the correct department, has not already been returned, is not subject to certain limitations regarding return, such as, for example, is a customization, is subject to sale item/clearance limitations, etc. These verification rules may be set up in advance by the system operator as desired. Additionally, the system 200 may be provided with logic such that the user interface only allows items that can be returned/exchanged are displayed to the user to avoid possible mistakes by the user and/or to avoid frustration when the user attempts to return/exchange the item only to learn that certain restrictions are in place that prohibit the user for doing so.

Still further, in at least some example the system 200 is provided with access to accounting rules to ensure that any accounting policies are implemented during the return and/or exchange. These rules may include, for instance, rules regarding seasonal items, coupon processing, taxes, exchange value, rewards and/or loyalty programs, time limits, etc. The implemented accounting rules may be changed, eliminated, overridden, and/or updated as desired. In some examples, the system 200 may also be provided with accounting and/or policy rules designed to detect and/or prevent fraud or other illegal activity at either the system 200 level, or on the account payment system, such as credit card and/or bank fraud.

Yet further, the system 200 may be provided with the ability to monitor and/or otherwise audit the steps performed by the system 200. For example, the system 200 may be provided with the ability to determine whether the user 210 has receipt, processed, and/or otherwise acted upon the user authorization code sent by the system 200. Additionally, the system 200 may be provided with the ability to send reminders and/or otherwise facilitate the return/exchange transaction. As noted above, the system 200 can send reminders and/or updates regarding the return/exchange, and may also be configured to provide inventory status updates to the user as desired. If the user loses and/or otherwise forgets the authorization code, the system 200 may be configured to recreate the authorization code, or otherwise process the return/exchange as a typical return/exchange utilizing the sales receipt, or other identification such as the user profile, item label, original credit card, etc.

Additionally, the store location 280 may be provided with various features and/or enhancements to further speed the consumer 210 through the return/exchange process. For example, the store location 280 may be provided with curb-side and/or “valet”-type processing to quickly move the consumer through the process because the return/exchange has already been processed and authorized behind the scenes. The system 200 may also allow for cancellation of the transaction as desired by either the user 210, or the system 200, such as for example, during a time-out condition, or due to a change in the accounting/policy rules noted above. Finally, because the system 200 may incentivize the user 210 to utilize the system 200 by providing a reward is the process is not performed within a certain time limit, the system 200 may implement various policy limitation, such as item size, number of items, etc., to provide a fair chance for the system 200 to meet the desired performance matrix.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

1. A computer-readable media having stored thereon computer executable instructions, wherein the instructions perform steps for allowing a user to manage at least one of a return or exchange of an ordered item, comprising:
hosting a database of information regarding item purchases;
providing a user interface comprising user interface elements for allowing a user to specify an item which is to be at least one of returned to or exchanged at a physical location, wherein the user interface provides the user the ability to provide identifying information regarding at least one of the user or the item;
receiving the identifying information from the user interface;
matching the identifying information with information in the database;
performing an authorization verification against at least one of a predefined accounting or policy rule to provide authorization for the return or exchange of the item;
providing to the user an identifier reflective of the authorization;
receiving at the physical location the item and the identifier; and
accepting the item, wherein the steps of receiving the item and accepting the item are performed within a predefined time limit, and wherein the user is provided with a reward if the steps are not performed within the predefined time limit.

2. A computer readable media as defined in claim 1, further comprising providing to the user an item in exchange for the item received at the physical location.

3. A computer readable media as defined in claim 2, further comprising:
hosting a database of information regarding inventory; and
placing a hold on inventory reflective of the item in exchange at the physical location prior to receiving item at the physical location.

4. A computer readable media as defined in claim 2, further comprising providing the user with the ability to inspect and approve the item in exchange.

5. A computer readable media as defined in claim 2, further comprising:
hosting a database of information regarding inventory; and
providing a user interface comprising user interface elements for allowing the user to view inventory and select the item for exchange.

6. A computer readable media as defined in claim 5, wherein the database of information regarding inventory includes information regarding the physical location of the inventory, and wherein the user interface provide user interface elements for allowing the user to change the physical location based upon inventory availability.

7. A computer readable media as defined in claim 5, wherein performing the authorization verification includes the step of determining any cost differential between the item and the item for exchange.

8. A computer readable media as defined in claim 7, wherein the cost differential is at least one of created or debited to an account associated with the user.

9. A computer readable media as defined in claim 1, further comprising receiving information reflective of the location of the user.

10. A computer readable media as defined in claim 9, wherein the information reflective of the location of the user allows for the prediction of the arrival time of the item at the physical location.

11. A computer readable media as defined in claim 9, wherein the information reflective of the location of the user is provided by at least one of Global Positioning System tracking, cell phone location, mobile application, status updates, direct calling, or short message service.

12. A computer readable media as defined in claim 1, wherein the predefined time limit is approximately five minutes.

13. A computer readable media as defined in claim 1, wherein receiving the item and the identifier, and accepting of the item are performed without use of a point-of-sale terminal.

14. A computer readable media as defined in claim 1, wherein the step of performing the authorization includes a credit reflective of the value of the item to an account associated with the user.

15. A computer readable media as defined in claim 1, further comprising:
hosting a database regarding user account information; and
updating the user account information to reflect the return or exchange of the item.

16. A computer readable media as defined in claim 1, further comprising:
hosting a database regarding user account information and reward information regarding the user account; and
at least one of crediting or debiting the reward information based upon the return or exchange of the item.

17. A computer readable media as defined in claim 1, further comprising providing a location within the physical location purposed to receive the item and the identifier and to accept the item.

18. A method for allowing a user to manage at least one of a return or exchange of an ordered item, comprising:
hosting an electronic database of information regarding item purchases;
providing a user interface comprising user interface elements for allowing a user to specify an item which is to be at least one of returned to or exchanged at a physical location, wherein the user interface provides the user the ability to provide identifying information regarding at least one of the user or the item;
receiving the identifying information from the user interface;
matching the identifying information with information in the database;
performing an authorization verification against at least one of a predefined accounting or policy rule to provide authorization for the return or exchange of the item;
providing to the user an identifier to identify the authorization;
receiving at the physical location the item and the identifier; and
accepting the item, wherein the steps of receiving the item and accepting the item are performed within a predefined time limit.

19. A method as defined in claim 18, wherein the user is provided with a reward if the steps receiving the item and accepting the item are not performed within the predefined time limit.

20. A method as defined in claim 18, further comprising providing to the user an item in exchange for the item received at the physical location.

21. A method as defined in claim 20, further comprising:
hosting an electronic database of information regarding inventory; and
placing a hold on inventory reflective of the item in exchange at the physical location prior to receiving item at the physical location.

22. A method as defined in claim 21, further comprising providing the user with the ability to inspect and approve the item in exchange.

23. A method as defined in claim 21, further comprising:
hosting a database of information regarding inventory; and
providing a user interface comprising user interface elements for allowing the user to view inventory and select the item for exchange.

24. A method as defined in claim 23, wherein the database of information regarding inventory includes information regarding the physical location of the inventory, and wherein the user interface provide user interface elements for allowing the user to change the physical location based upon inventory availability.

25. A method as defined in claim 23, wherein performing the authorization verification includes the step of determining any cost differential between the item and the item for exchange.

26. A method as defined in claim 25, wherein the cost differential is at least one of created or debited to an account associated with the user.

27. A method as defined in claim 18, further comprising receiving information reflective of the location of the user.

28. A method as defined in claim 27, wherein the information reflective of the location of the user allows for the prediction of the arrival time of the item at the physical location.

29. A method as defined in claim 27, wherein the information reflective of the location of the user is provided by at least one of Global Positioning System tracking, cell phone location, mobile application, status updates, direct calling, or short message service.

30. A method as defined in claim 18, wherein the predefined time limit is approximately five minutes.

31. A method as defined in claim 18, wherein receiving the item and the identifier, and accepting of the item are performed without use of a point-of-sale terminal.

32. A method as defined in claim 18, wherein the step of performing the authorization includes a credit reflective of the value of the item to an account associated with the user.

33. A method as defined in claim 18, further comprising:
hosting a database regarding user account information; and
updating the user account information to reflect the return or exchange of the item.

34. A method as defined in claim 18, further comprising:
hosting a database regarding user account information and reward information regarding the user account; and
at least one of crediting or debiting the reward information based upon the return or exchange of the item.

35. A method as defined in claim 18, further comprising providing a location within the physical location purposed to receive the item and the identifier and to accept the item.

36. A computer-readable media having stored thereon computer executable instructions, wherein the instructions perform steps for allowing a user to manage at least one of a return or exchange of at least one item, comprising:
hosting a database of information regarding item purchases;
providing a user interface comprising user interface elements for allowing a user to specify at least one of the at least one item which is to be at least one of returned to or exchanged at a physical location, wherein the user interface provides the user the ability to provide identifying information regarding at least one of the user or the at least one of the at least one item, and wherein the user interface further provides the user the ability to at least one schedule or estimate a time for conducting the return or exchange;
receiving the identifying information from the user interface;
matching the identifying information with information in the database;
performing an authorization verification against at least one of a predefined accounting or policy rule to provide authorization for the return or exchange of the item;
providing to the user an identifier reflective of the authorization;
receiving at the physical location the item, the identifier and the at least one of the scheduled or estimated time for conducting the return or exchange; and
accepting the item, wherein the steps of receiving the item and accepting the item are performed at the scheduled or estimated time for conducting the return or exchange.
